(19) United States
(12) Patent Application Publication
(10) Pub. No.: US 2009/0083213 A1
(43) Pub. Date: Mar. 26, 2009

(54) Method and System for Fast Navigation in a Hierarchical Tree Control

(76) Inventors: Thomas R. Haynes, Apex, NC (US); Lin Sun, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/858,734

(22) Filed: Sep. 20, 2007

(51) Int. Cl. G06F 17/30

(52) U.S. Cl. 707/2; 707/E17.01

(57) ABSTRACT

A method, system, and computer program product for fast navigation in a hierarchical tree control. A user is able to navigate more efficiently to a target file, folder or other artifact by eliminating the need to individually expand on any intervening folders that are above in hierarchy to the target file or folder. Under a fast navigation mode, a fast navigation utility displays a hierarchical tree control based on one or more fast navigation display formats. The fast navigation display formats control (i) the type of content that is displayed in the hierarchical tree control and (ii) how the hierarchical tree control is visually displayed to a user.

### BACKGROUND OF THE INVENTION

1. Technical Field

The present invention relates in general to interface technologies and in particular to display interface technologies. Still more particularly, the present invention relates to an improved method and system for navigating in a hierarchical tree control.

2. Description of the Related Art

Existing methods of navigating through a hierarchical tree control that is displayed using a graphical user interface (GUI) are inefficient at arriving at a desired file or folder. This statement is especially true if a user has some preexisting familiarity with the particular name, location or properties of the file/folder. As an example, consider the scenario in which a user wishes to locate and select a file named “file1.doc”, which is located along the path “C:\mainfolder\subfolder1\subfolder2\subfolder3\subfolder4\file1.doc”. Using conventional mouse navigation, the user would be required to: 1) locate and expand the “C:\” directory, 2) locate and expand the folder called “mainfolder”, 3) locate and expand the folder called “subfolder1”, 4) locate and expand the folder called “subfolder 2”, 5) locate and expand the folder called “subfolder 3”, 6) locate and expand the folder called “subfolder 4”, and finally 7) locate and select the file called “file1.doc”. Such methods of mouse navigation are not time efficient, as they may require the user to unnecessarily traverse several intervening folders before reaching the target file/folder.

### SUMMARY OF THE ILLUSTRATIVE EMBODIMENT

Disclosed is a method, system, and computer program product for fast navigation in a hierarchical tree control. A request is received to retrieve a specific type of artifact. The artifact includes one or more files and/or folders. A fast navigation mode is initiated to retrieve the artifact. The one or more artifacts are outputted according to at least one fast navigation display format from among an artifact format, an extension format, a subdirectory format, a flat view format, a tree view format, and a distinguisher format.

According to one embodiment of the invention, a launch of a hierarchical tree control is detected from a specific application type. As a result, one or more files corresponding to an extension associated with the specific application type is displayed. According to yet another embodiment of the invention, a navigation selection of an artifact that is outputted is detected. As a result, at least one selection display datum corresponding to the navigation selected artifact is displayed. The selection display datum that is displayed includes at least one of a full navigation path, a modified timestamp datum, and a file size datum. According to yet another embodiment of the invention, a simultaneous display of artifacts corresponding to different subdirectory levels is detected. As a result, an artifact of a first subdirectory level is displayed with a first distinguisher that is different from a second distinguisher of a displayed artifact of a second subdirectory level. In this regard, the distinguisher of the first displayed artifact of a first subdirectory can have a different color or icon as compared to an artifact(s) of a different subdirectory.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a high level block diagram of an exemplary data processing system, according to an embodiment of the invention;

FIG. 2 shows an exemplary list of artifacts of a sample directory, C:\directory, that is useful for understanding the invention;

FIG. 3A shows a hierarchical tree control in a flat view of artifacts of FIG. 2, according to an embodiment of the invention;

FIG. 3B shows a hierarchical tree control in a tree view of artifacts of FIG. 2, according to an embodiment of the invention;

FIG. 4 shows a hierarchical tree control in a flat view displaying a selected number of subdirectory levels, according to an embodiment of the invention;

FIG. 5 shows a hierarchical tree control in a flat view that displays folders of sample directory of FIG. 2, according to an embodiment of the invention;

FIG. 6 shows a hierarchical tree control in a flat view that displays files of sample directory of FIG. 2, according to an embodiment of the invention;

FIG. 7 shows a hierarchical tree control in flat view that displays files of sample directory of FIG. 2 having extensions associated with a specific application type, according to an embodiment of the invention;

FIG. 8 is a high level logical flowchart of an exemplary method of fast navigation in a hierarchical tree control, according to an embodiment of the invention.

### DETAILED DESCRIPTION OF AN ILLUSTRATIVE EMBODIMENT

The present invention provides a method, system, and computer program product for fast navigation in a hierarchical tree control. The present invention enables a user to efficiently navigate to a target file, folder or other artifact by eliminating the need to individually find and expand intervening folders that are above in hierarchy to the target file or folder. Under a fast navigation mode, a fast navigation utility displays a hierarchical tree control based on one or more fast navigation display formats. The fast navigation display formats control (i) the type of content that is displayed in the hierarchical tree control and (ii) how the hierarchical tree control is visually displayed to a user.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

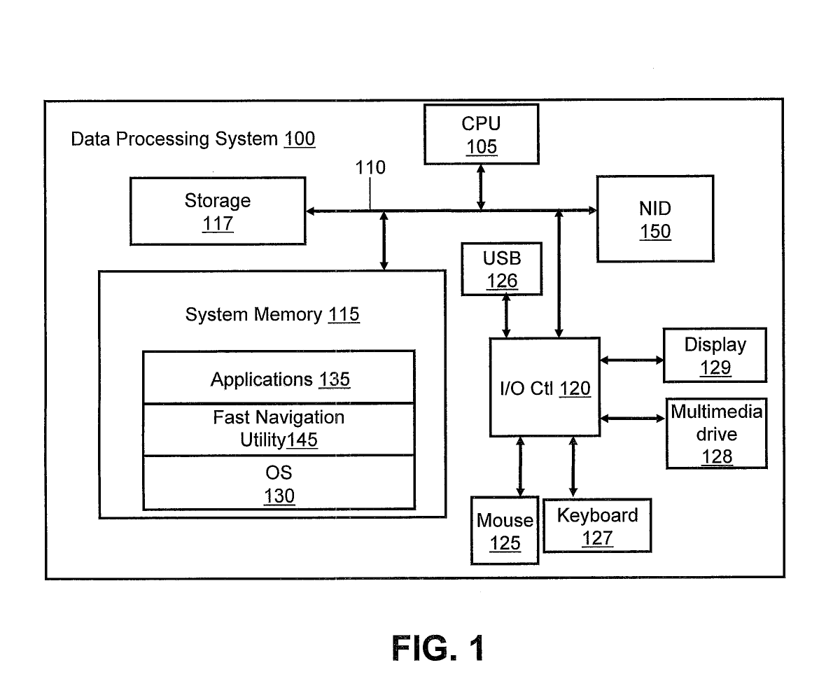

With reference now to FIG. 1, depicted is a block diagram representation of a data processing system (DPS) 100. DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, a multimedia drive 128 (e.g., CDRW or DVDRW drive) and Universal Serial Bus (USB) hub 126 are illustrated, coupled to I/O controller 120. Multimedia drive 128 and USB hub 126 may operate as both input and output (storage) mechanisms. DPS 100 also comprises storage 117, within which data/instructions/code may be stored. DPS 100 is also illustrated with a network interface device (NID) 150 coupled to system bus 110. NID 150 enables DPS 100 to connect to one or more access networks, such as the Internet.

Notably, in addition to the above described hardware components of DPS 100, various features of the invention are completed via software (or firmware) code or logic stored within system memory 115 or other storage (e.g., storage 117) and executed by CPU 105. In one embodiment, data/instructions/code from storage 117 populates the system memory 115, which is also coupled to system bus 110. System memory 115 is defined as a lowest level of volatile memory (not shown), including, but not limited to, cache memory, registers, and buffers. Thus, illustrated within system memory 115 are a number of software/firmware components, including operating system (OS) 130 (e.g., Microsoft Windows®, a trademark of Microsoft Corp; or GNU®/Linux®, registered trademarks of the Free Software Foundation and The Linux Mark Institute; or Advanced Interactive eXecutive —AIX—, registered trademark of International Business Machines—IBM), applications 135, and a Fast Navigation utility 145. In actual implementation, components or code of OS 130 may be combined with those of Fast Navigation utility 145 or vice versa, collectively providing the various functional features of the invention when the corresponding code is executed by the CPU 105. For simplicity, Fast Navigation utility 145 is illustrated and described as a stand alone or separate software/firmware component, which is stored in system memory 115 to provide/support the specific novel functions described herein.

CPU 105 executes Fast Navigation utility 145 as well as OS 130, which supports the user interface (UI) features of Fast Navigation utility 145. In the illustrative embodiment, Fast Navigation utility 145 enables a more efficient navigation through a hierarchical tree control to one or more specific artifacts (i.e., file and/or folder) of the hierarchical tree control. Among the software code/instructions provided by Fast Navigation utility 145, and which are specific to the invention, are code for: (a) receiving a request to retrieve a specific type of artifact including at least one of a file and a folder; (b) initiating a fast navigation mode to retrieve the artifact; and (c) outputting the one or more artifacts according to one or more fast navigation display formats.

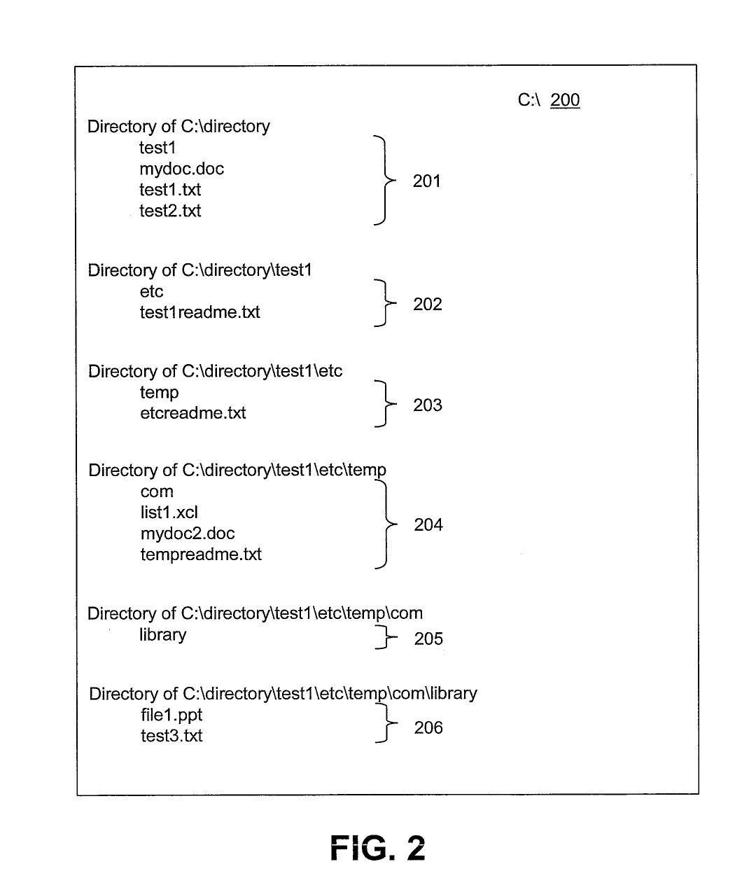

For simplicity of the description, the collective body of code that enables these various features is referred to herein as Fast Navigation utility 145. According to the illustrative embodiment, when CPU 105 executes Fast Navigation utility 145, DPS 100 initiates a series of functional processes that enable the above functional features as well as additional features/functionality, which are described below within the descriptions of FIGS. 2-8.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the AIX operating system or LINUX operating system.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

With reference now to FIG. 2, there is depicted an exemplary directory C:\200, that includes various levels of subdirectories 201-206. In this regard, a directory contained inside another directory is called a “subdirectory” of that directory. A subdirectory is also referred to as a “child directory”, since the artifacts (i.e., files and/or folders) contained in the subdirectory are originating hierarchically from a folder contained in a “parent directory”. The “parent directory” originates from a level that is hierarchically superior to the “child directory”. Moreover, there can be parent directories that serve as “child directories” to other hierarchically superior “parent directories”. For example, subdirectory 201 serves as a parent directory to subdirectory 202, since folder “test1” of subdirectory one 201 can be further expanded to reveal the contents (i.e. folder “etc” and file “test1readme.txt”) of subdirectory two 202. At the same time, however, subdirectory 201 serves as a child directory to its parent directory, C:\200. Together, directory C:\200 and its various subdirectories 201-206 form a hierarchical tree control.

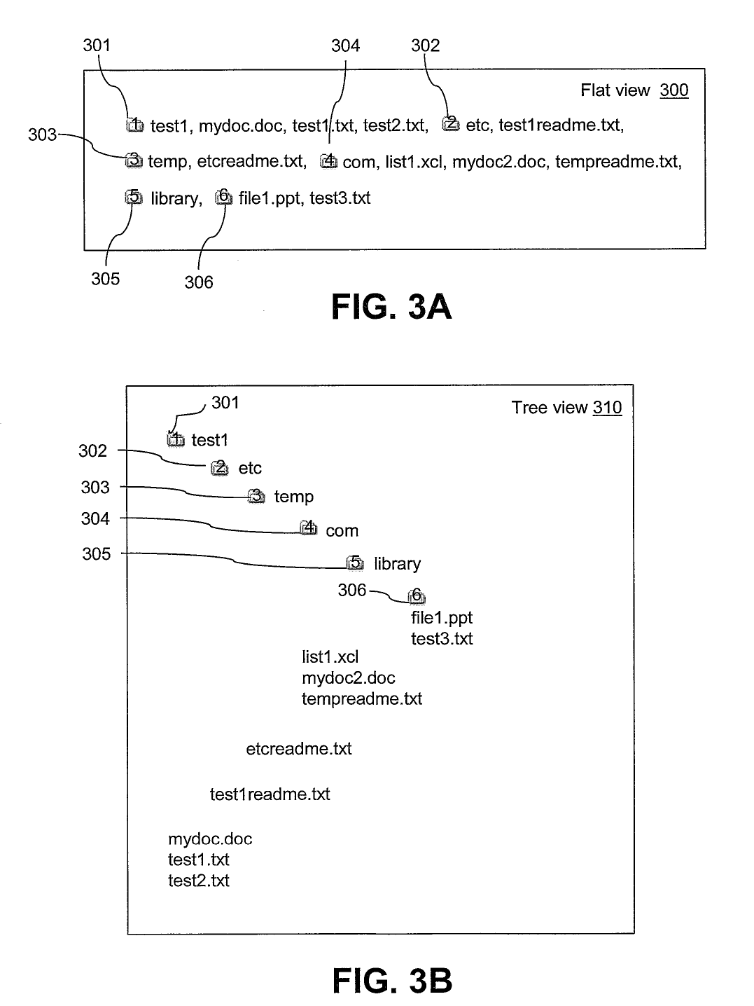

Referring now to FIG. 3A, a “flat” view representation 300 of the artifact contents of exemplary directory C:\200 (FIG. 2) is shown. As used herein, a “flat” view is defined as a view on display 129 (FIG. 1) in which the files and/or folders of a hierarchical tree control are listed linearly across the display 129 in a sequential left-to-right and descending line-by-line format. Moreover, each list of artifacts corresponding to a particular subdirectory is preceded by a distinguisher. According to the present embodiment, the distinguisher is represented by icons 301-306 depicting a conventional folder-like icon. In addition, each icon 301-306 is labeled with a number associated with a particular subdirectory level. For example, icon 301 is associated with folder test1, as well as files mydoc.doc, test1.txt, and test2.txt. However, the invention is not limited in this regard, and any number of different distinguishers may be used to differentiate or identify the artifacts of one subdirectory from those of another simultaneously displayed subdirectory. For example, artifacts from a particular subdirectory can be displayed using a specific color (not shown) that is different from other listed artifacts of another subdirectory. Moreover, according to the embodiment depicted in FIG. 3A, each subdirectory contains its own hierarchy in that the folder artifact(s) of each subdirectory is/are displayed before displaying the file artifacts grouped within the same subdirectory. However, the invention is not limited to any one particular hierarchy within a subdirectory. In this regard, a user may choose to sort the artifacts within a subdirectory by: alphabetical order, file extension order, last modified date/time order, usage frequency order, and/or most recently usaged order.

Referring now to FIG. 3B, an alternative “tree” view representation 310 of the artifact contents of exemplary directory C:\200 (FIG. 2) is shown. Tree view representation 310 differs primarily from flat view representation 300 in the way the hierarchical tree control is arranged. In this regard, tree view representation 310 is arranged in a more hierarchical, stepped order as compared to flat view representation 300. Despite this difference, flat view representation 300 and tree view representation 310 display a fully expanded view of all artifacts contained within C:\200, thus enabling a user to quickly identify and select a particular artifact of interest.

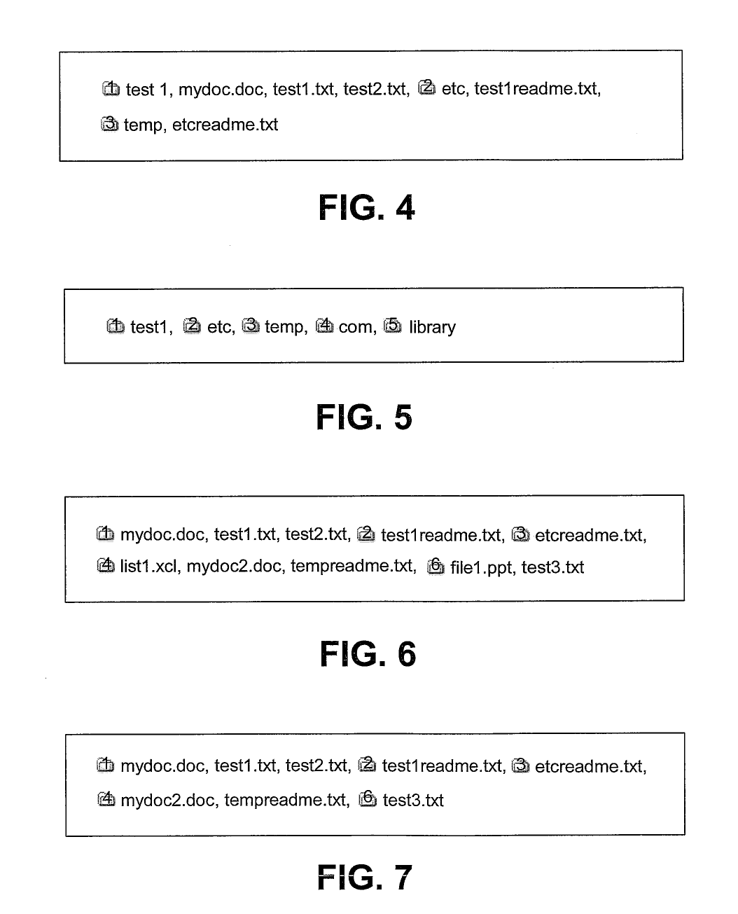

With collective reference now to FIGS. 4-7, shown are various flat view representations of hierarchical tree controls having content-based navigation display formats. In contrast to visual-based navigation display formats (i.e., flat view format 300 and tree view format 310), which control “how” the artifacts are visually arranged on a display 129, a content-based navigation display format determines “which” artifacts are to be displayed. Referring now to FIG. 4, shown is an exemplary flat view representation of a hierarchical tree control having a subdirectory format that exclusively displays the artifact contents of user-selected subdirectory levels 1-3. In this regard, the number of user-selected subdirectory levels that are displayed in hierarchical tree control example shown in FIG. 4 having the subdirectory format should not limit the scope of the invention, as any number and combination of subdirectory levels may be selected for display.

Referring now to FIG. 5, shown is a flat view representation of a hierarchical tree control that exclusively displays folder artifacts, as determined by an artifact format. As used herein, an artifact format is a type of content-based navigation display format which controls whether files, folders, or a combination thereof of are to be displayed. The artifact format can be quite useful for a user who may have some familiarity with the hierarchical tree control in which the user is searching and does not want to parse through particular artifact types. In the exemplary hierarchical tree control shown in FIG. 5, the user may not know the actual name of a target file, but may be familiar with a particular folder(s) which may contain the target file.

Referring now to FIG. 6, a flat view representation of a hierarchical tree control is shown that exclusively displays file artifacts as determined by the artifact format. The exemplary embodiment of FIG. 6 can assist the user when the user may not remember the target file name, but may remember that the target file name was listed with a set of files that are familiar to the user. For instance, if a user does not know the actual name of the target file (e.g., tempreadme.txt), but the user remembers that the target file was grouped with a particularly named file (e.g., mydoc2.doc), the user can select to view only file artifacts, as shown in FIG. 6. Instead of parsing through folder names, the user can more efficiently search for the known named file (mydoc2.doc), and then the associated target file (tempreadme.txt).

Referring now to FIG. 7, a flat view representation of a hierarchical tree control is shown, whereby an extension format controls the type of file extensions that are displayed to the user. According to the exemplary embodiment illustrated in FIG. 7, the user can search through a hierarchical tree structure containing files having extensions .doc and .txt. According to an alternative embodiment, the extension format of a hierarchical tree control can be dependent upon the particular application type from which the hierarchical tree control is launched. In the example shown in FIG. 7, the hierarchical tree control is launched from a word processing application type. As a result, the extension format will exclusively display all available files within the C:\200 (FIG. 2) having extensions that can be used with the particular word processing application type. In this regard, it should be appreciated that the extension format can be used for any type of file extension. In view of the various display formats shown in FIGS. 3A-7, it should be understood that the particular combination of displayed formats and the order in which the formats are displayed to a user can change depending on the user's preferences. Moreover, the user can designate a default format or a default combination of formats.

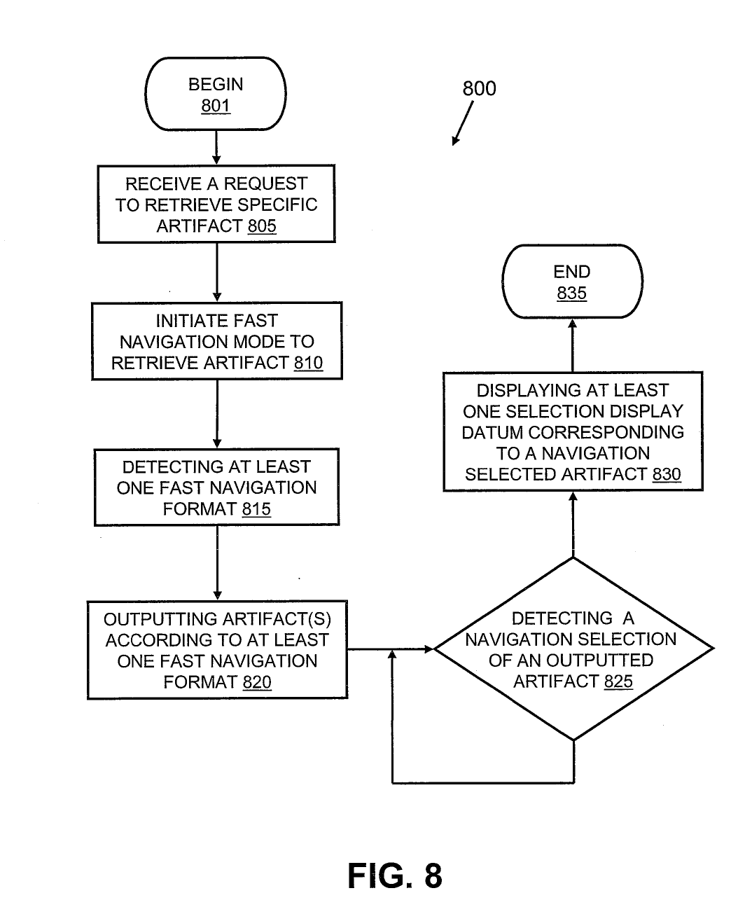

Referring now to FIG. 8, a flowchart is presented of exemplary steps used to implement and utilize the method 800 of fast-navigation through a hierarchical tree control, according to an illustrative embodiment of the invention. After initiator block 801, a request is received to retrieve one or more artifacts contained within a current parent directory (block 805). The artifact can be a file, a folder, or the like. The received request can be initiated by an input device, such as a mouse 125 (FIG. 1), a keyboard 127 (FIG. 1), a touchpad, a track ball, a touch screen, or the like, or any other known or later developed device that is capable of inputting data and control signals to the input/output control 120 (FIG. 1). A fast-navigation mode is then initiated to retrieve the artifact(s) to be displayed in the hierarchical tree control (block 810).

After the fast-navigation mode has been initiated, fast navigation utility 145 (FIG. 1) detects one or more fast navigation formats from among the: artifact format, extension format, subdirectory format, flat view format, tree view format, and distinguisher format, as depicted in block 815. The artifact format displays one or more files, one or more folders, or a combination thereof. The extension format displays one or more files from a group having one or more extension types. The subdirectory format displays artifacts from a selected number of subdirectory levels. The flat view format displays a hierarchical tree control containing a list of artifacts in a left-to-right, top-to-bottom, line-by-line view. The tree view format displays the artifacts of a hierarchical tree control in a stepped hierarchical view representation. Notably, the flat view and the tree view formats display all artifacts contained within current parent directory, without having to perform further expansion of a folder within the current parent directory. Further broadening or narrowing of a displayed hierarchical tree control is dependent upon the subdirectory level location of the folder to be selected as the current parent directory.

As described above in FIGS. 3A-7, each fast navigation format controls “how” and “which” artifacts are displayed in a hierarchical tree control. The retrieved artifact(s) are then outputted to a display 129 (FIG. 1) according to one or more fast navigation formats, as depicted in block 820. The display 129 can be any known or later developed display device, including a cathode ray tube type monitor, a flat screen type monitor, an LCD monitor, or any other known or later developed device on which the graphical hierarchical tree control can be displayed and interacted with using one or more of the input devices.

At decision block 825, it is determined whether a navigation selection of an outputted artifact is detected. As used herein, the term “navigation selection” is defined as an action that selects a particular outputted artifact. The navigation selection can be actualized in several ways. One such way is hovering a mouse pointer over the selected artifact appearing on display 129. The method 800 waits at block 825 until such navigation selection is detected, and then proceeds to block 830. Once a navigation selection is detected, at least one selection display datum corresponding exclusively to the navigation selected artifact is automatically displayed, as depicted in block 830. As a result, the user is provided with readily accessible information regarding the navigation selected artifact. The selection display datum that is displayed includes at least one of a full navigation path, a modified timestamp datum, and a file size datum. Using the exemplary hierarchical tree control 300 (FIG. 3A) as an example, if the file named “test3.txt” were to be navigation selected, the following full navigation path would be displayed (i.e., C:\directory\test1 \etc\temp\com\library\test3.txt). The process ends at terminator block 835.

In the flow chart above (FIG. 8), one or more of the methods are embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware, or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, and the like, thereby making an article of manufacture in accordance with the invention. The article of manufacture containing the programming code is used by either executing the code directly from the storage device, by copying the code from the storage device into another storage device such as a hard disk, RAM, and the like, or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVD ROMs, and transmission type media such as digital and analog communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for fast navigation in a hierarchical tree control comprising:
receiving a request to retrieve a specific type of artifact including at least one of a file and a folder;
initiating a fast navigation mode to retrieve the artifact; and
outputting the one or more artifacts according to one or more fast navigation display formats;
wherein the fast navigation display format includes at least one of an artifact format displaying at least one of a file and a folder, an extension format displaying one or more files from a group having one or more extension types, a subdirectory format displaying artifacts from a selected number of subdirectory levels, a flat view format, a tree view format, and a distinguisher format.

2. The method of claim 1, the method further comprising:
detecting a launch of a hierarchical tree control from a specific application type; and
displaying one or more files having an extension associated with the specific application type.

3. The method of claim 1, the method further comprising:
detecting a navigation selection of an artifact that is outputted; and
displaying at least one selection display datum corresponding to the navigation selected artifact;
wherein the at least one selection display datum includes at least one of a full navigation path, a modified timestamp datum, and a file size datum.

4. The method of claim 1, the method further comprising:
detecting a simultaneous display of artifacts corresponding to different subdirectory levels; and
displaying an artifact of a first subdirectory level with a first distinguisher that is different from a second distinguisher of a displayed artifact of a second subdirectory level.

5. A computer system comprising:
a processor unit;
a memory coupled to the processor unit; and
a tree control utility executing on the processor unit and having executable code for:
receiving a request to retrieve a specific type of artifact including at least one of a file and a folder;
initiating a fast navigation mode to retrieve the artifact; and
outputting the one or more artifacts according to one or more fast navigation display formats;
wherein the fast navigation display format includes at least one of an artifact format displaying at least one of a file and a folder, an extension format displaying one or more files from a group having one or more extension types, a subdirectory format displaying artifacts from a selected number of subdirectory levels, a flat view format, a tree view format, and a distinguisher format.

6. The computer system of claim 5, the tree control utility further having executable code for:
detecting a launch of a hierarchical tree control from a specific application type; and
displaying one or more files having an extension associated with the specific application type.

7. The computer system of claim 5, the tree control utility further having executable code for:
detecting a navigation selection of an artifact that is outputted; and
displaying at least one selection display datum corresponding to the navigation selected artifact;
wherein the at least one selection display datum includes at least one of a full navigation path, a modified timestamp datum, and a file size datum.

8. The computer system of claim 5, the tree control utility further having executable code for:
detecting a simultaneous display of artifacts corresponding to different subdirectory levels; and
displaying an artifact of a first subdirectory level with a first distinguisher that is different from a second distinguisher of a displayed artifact of a second subdirectory level.

9. A computer program product comprising:
a computer storage medium; and
program code on the computer storage medium that when executed provides the functions of:
receiving a request to retrieve a specific type of artifact including at least one of a file and a folder;
initiating a fast navigation mode to retrieve the artifact; and
outputting the one or more artifacts according to one or more fast navigation display formats;
wherein the fast navigation display format includes at least one of an artifact format displaying at least one of a file and a folder, an extension format displaying one or more files from a group having one or more extension types, a subdirectory format displaying artifacts from a selected number of subdirectory levels, a flat view format, a tree view format, and a distinguisher format.

10. The computer program product of claim 9, the program code further provides the functions of:
detecting a launch of a hierarchical tree control from a specific application type; and
displaying one or more files having an extension associated with the specific application type.

11. The computer program product of claim 9, the program code further provides the functions of:
detecting a navigation selection of an artifact that is outputted; and
displaying at least one selection display datum corresponding to the navigation selected artifact;
wherein the at least one selection display datum includes at least one of a full navigation path, a modified timestamp datum, and a file size datum.

12. The computer program product of claim 9, the program code further provides the functions of:
detecting a simultaneous display of artifacts corresponding to different subdirectory levels; and
displaying an artifact of a first subdirectory level with a first distinguisher that is different from a second distinguisher of a displayed artifact of a second subdirectory level.
